(19) United States
(12) Patent Application Publication
(10) Pub. No.: US 2011/0064362 A1
(43) Pub. Date: Mar. 17, 2011

(54) INTEGRATED CIRCUIT DEVICE OR PACKAGE AND INTEGRATED CIRCUIT SYSTEM, WITH AN OPTICAL WAVE-GUIDE ELEMENT

(75) Inventors: Nedyalko Slavov, Zurich (CH); Heinz-Peter Wirtz, Dottingen (CH); Kwei-Kuan Kuo, Zurich (CH)

(73) Assignee: ST-ERICSSON SA, Geneva (CH)

(21) Appl. No.: 12/558,419

(22) Filed: Sep. 11, 2009

(51) Int. Cl. G02B 6/36

(52) U.S. Cl. 385/88; 385/14

(57) ABSTRACT

An integrated circuit device or package comprising: a laminated substrate, at least an electro-optical element at least partially inserted in the laminated substrate, and at least an optical wave-guide element at least partially inserted in the laminated substrate and optically coupled to the electro-optical element. An integrated circuit system comprising an integrated circuit device and a mounting plate carrying an optical wave-guide part or fiber.

### BACKGROUND

1. Technical Field

The present disclosure relates to the field of integrated circuit devices or packages and integrated circuit systems.

2. Description of the Related Art

Currently, integrated circuit devices or packages are mounted on printing plates by means of wires or solder balls, which are used for electrical interconnections, in particular for data transmissions.

### BRIEF SUMMARY

It is proposed an integrated circuit device, comprising a laminated substrate, at least an electro-optical element at least partially inserted in the laminated substrate, and at least an optical wave-guide element at least partially inserted in the laminated substrate and optically coupled to the electro-optical element.

The laminated substrate can comprise a cavity in which the electro-optical element and the optical wave-guide element are at least partially inserted.

The laminated substrate can include an electrical connection network connected to the electro-optical element.

The optical wave-guide element can include a fixing end part inserted in the laminate substrate and optically coupled to the electro-optical element and another end turned outside of the laminated substrate.

The laminated substrate can comprise a cavity in which the electro-optical element and a fixing end part of the optical wave-guide element are inserted.

The fixing end part of the optical wave-guide element can include a peripheral shoulder inserted in a passage of a core layer of the laminated substrate.

The laminated substrate can include at least a side layer placed above at least a side of the core layer.

The laminated substrate can include a core layer having at least a through-passage in which the electro-optical element and a shoulder of a fixing end part of the optical wave-guide element are inserted and side layers placed above the sides of the core layer and extended one above the electro-optical element and the other one above the shoulder of the optical wave-guide element.

An integrated circuit die can be located at the opposite side of the optical wave-guide element and connected to an electrical connection network.

A device can comprise an encapsulated means encapsulating the integrated circuit die and the connection means connecting the integrated circuit die and an electrical connection network.

It is also proposed an integrated circuit system, comprising an integrated circuit device, and comprising further a mounting plate on which the integrated circuit device is mounted by electrical connection means placed between the laminated substrate and the mounting plate, the mounting plate comprising at least an optical wave-guide part coupled to the optical wave-guide element.

It is also proposed an integrated circuit system, comprising an integrated circuit device according, and comprising further a mounting plate on which the integrated circuit device is mounted by electrical connection means placed between the laminated substrate and the mounting plate, the mounting plate carrying at least an optical wave-guide fiber having an end coupled to the optical wave-guide element.

The optical wave-guide fiber can extend through a crossing hole of the mounting plate.

The optical wave-guide fiber can be fixed to the mounting plate by means of at least a ring.

The optical wave-guide element can have an end part in said ring.

### BRIEF DESCRIPTION OF THE SEVERAL VIEWS OF THE DRAWINGS

Other advantages and features will become apparent by studying integrated circuit systems, described by way of non-limited examples and illustrated by the appended drawings in which:

FIG. 1 represents a cross section of an integrated circuit system;

FIG. 2 represents a cross section of another integrated circuit system;

FIG. 3 represents a cross section of an intermediate step of fabrication of an integrated circuit device of FIG. 1;

FIG. 4 represents a cross section of another intermediate step of fabrication of an integrated circuit device of FIG. 1;

FIG. 5 represents a cross section of another intermediate step of fabrication of an integrated circuit device of FIG. 1; and

FIG. 6 represents a cross section of another intermediate step of fabrication of an integrated circuit device of FIG. 1.

### DETAILED DESCRIPTION

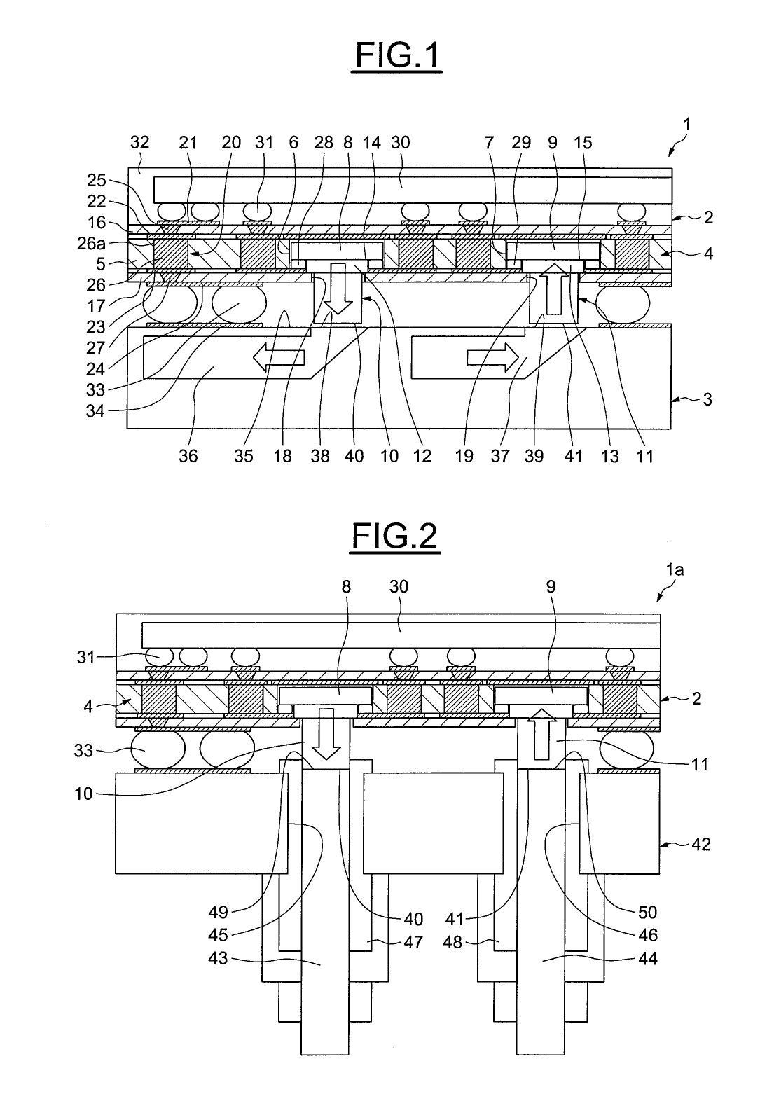

Referring to FIG. 1, it can be seen that an integrated circuit system 1 is represented, comprising an integrated circuit device or package 2 and a connection mounting plate 3.

The package 2 includes a laminated substrate 4 which comprises a dielectric core layer 5 having at least two through-passages 6 and 7 spaced apart from each other.

The package 2 includes an electro-optical element 8 such as an emitting diode and an electro-optical element 9 such as a receiving diode which are respectively inserted or integrated in the passages 6 and 7 in the same direction of the thickness of the core layer 5.

The package 2 includes also an optical wave-guide element 10 optically coupled to the electro-optical element 8 and an optical wave-guide element 11 optically coupled to the electro-optical element 9. The electro-optical elements 8 and 9 can be cylindrical and extend in the same direction of the thickness of the core layer 5.

The optical wave-guide elements 10 and 11 comprise fixing end parts provided with peripheral shoulders 12 and 13 which are respectively inserted in the passages 6 and 7 of the core layer 5. The other end parts of the optical wave-guide elements 10 and 11 are turned outside of the laminated substrate 4.

The electro-optical element 8 and 9 and the fixing end parts of the optical wave-guide elements 10 and 11 are respectively stacked in the passages 6 and 7 in the same direction of the thickness of the core layer 5, the fixing end parts of the optical wave-guide elements 10 and 11 having radial end faces 14 and 15 which are optically coupled respectively to the electro-optical elements 8 and 9.

The laminated substrate 4 comprises further side dielectric build-up layers 16 and 17. The build-up layer 16 is located above a side of the core layer 5 and extends over faces of the electro-optical elements 8 and 9 opposite to the optical wave-guide elements 10 and 11. The build-up layer 17 is located above the other side of the core layer 5, presents through-passages 18 and 19 for passing the optical wave-guide elements 10 and 11 and extends over the shoulders 12 and 13 of the last opposite to the optical wave-guide elements 10 and 11.

The laminated substrate 4 of the package 2 includes a metal electrical connection network 20 which comprises a connection pattern 21 formed on the external face of the build-up layer 16, a connection pattern 22 formed between the core layer 5 and the build-up layer 16, a connection pattern 23 formed between the core layer 5 and the build-up layer 17, and an external connection pattern 24 formed on the external face of the build-up layer 17.

The electrical connection network 20 comprises further electrical vias 25 crossing the build-up layer 16 for connecting the connection pattern 21 and the connection pattern 22, electrical vias 26 crossing passages 26a of the core layer 5 for connecting the connection pattern 22 and the connection pattern 23, and electrical vias 27 crossing the build-up layer 17 for connecting the connection pattern 23 and the connection pattern 24.

The electrical connection network 20 comprises further connection bumps or pillars 28 and 29 located around the shoulders 12 and 13 in the passages 6 and 7 of the core layer 5 for connecting the electro-optical elements 8 and 9 to the connection pattern 23.

The thickness of, on one hand, the electro-optical elements 8 and the connection means 28 and the thickness of, on the other hand, the electro-optical elements 9 and the connection means 29 can be substantially equal to the thickness of the core layer 5.

The package 2 includes further an integrated circuit die 30, opposite to the optical wave-guide elements 10 and 11 and mounted by intermediate electrical connection balls 31 located between connection points of a face of the die 30 and the connection pattern 21.

The package 2 can include also an encapsulating block 32 which encapsulates the die 30 and the connection balls 31 above the external face of the side layer 16.

As an example, the package 2 can be manufactured according to the following steps.

Having a core layer plate, this plate is drilled for forming the passages 6 and 7 and the passages 26a.

A first metal layer is formed on a face of the drilled plate.

Electro-optical elements 8 and 9 with connection bumps or pillars 28 and 29 are inserted and fixed in the passages 6 and 7 and on the first layer, the optical face of these elements 8 and 9 and the connection bumps or pillars 28 and 29 being opposite to the first layer.

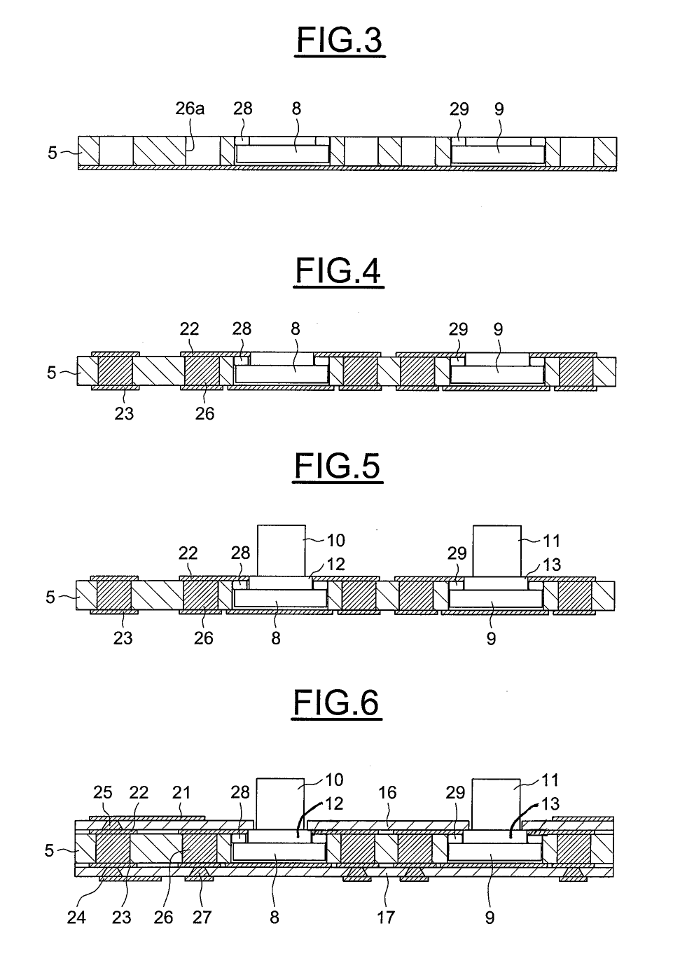

The structure obtained at the end of the above step is illustrated on FIG. 3.

The passages 26a are filled with a metal for forming the vias 26 and a second metal layer is formed on the other face of the drilled plate.

The first and second metal layers are etching in order to form connection patterns 22 and 23 and to form passages in front of the optical part of the electro-optical elements 8 and 9.

The structure obtained at the end of the above step is illustrated on FIG. 4.

The optical wave-guide elements 10 and 11 are installed, the shoulders 12 and 13 being inserted in the cavities. The radial end faces 14 and 15 of the optical wave-guide elements 10 and 11 are attached to the electro-optical elements 8 and 9 and or to the walls of the cavities by means of transparent glue.

The structure obtained at the end of the above step is illustrated on FIG. 5.

Having prepared a first side layer plate comprising a side layer 16, a connection pattern 21 and vias 25 and a second side layer plate comprising a side layer 17, a connection pattern 24 and vias 27, these first and second side layer plates are linked to the corresponding faces of the core layer plate.

The structure obtained at the end of the above step is illustrated on FIG. 6.

After that, an integrated circuit die 30 is attached by means of connection solder balls 31 and an encapsulated block 32 is formed for example by molding.

At the end of the above step, the integrated circuit package 2 is realized.

As illustrated on FIG. 1, the integrated circuit package 2 as above described can be carried by the connection mounting plate 3 by the intermediate of electrical connection solder balls 33 located between the connection pattern 24 and a printed-circuit pattern 34 formed on a face 35 of the mounting plate 3.

The mounting plate 3 includes further optical wave-guide parts 36 and 37 which are respectively optically coupled to the optical wave-guide elements 10 and 11. The optical wave-guide parts 36 and 37 can have end faces 38 and 39 formed at the level of the face 35 of the mounting plate 3 and optically coupled to radial end faces 40 and 41 of the optical wave-guide elements 10 and 11 opposite to the faces 14 and 15 of these elements.

The dimensions of the connection balls 33 and the length of the optical wave-guide elements 10 and 11 are in correspondence so that the end faces 40 and 41 of the optical wave-guide elements 10 and 11 are placed close to or in contact on the end faces 38 and 39 of the optical wave-guide parts 36 and 37 of the mounting plate 3.

It results from the above description the following advantages.

The core layer 5 gives the principle resistance of the substrate 4.

The electro-optical elements 8 and 9 and the fixing end part of the optical wave-guide elements 10 and 11 having eventually the shoulders 12 and 13 are inserted or integrated in cavities of the laminated substrate 4 formed in the passages 6 and 7 of the core layer 5 and eventually between the side layers 16 and 17.

Resulting from this integration, the electro-optical elements 8 and 9 and the optical wave-guide elements 10 and 11 are perfectly positioned.

The electrical connection network 20 can be used for selectively connecting the integrated circuit die 30 to the printed-circuit pattern 34 of the mounting plate 3 for connections to other components, and for connecting selectively the optical wave-guide elements 10 and 11 to the integrated circuit die 30 and eventually to the printed electrical connection pattern 34 of the mounting plate 3 for connections to other components.

The data having to be transferred between the integrated circuit die 30 and external components can be performed by using the optical links including the electro-optical elements 8 and 9, the optical wave-guide elements 10 and 11 of the package 2 and the optical wave-guide parts 36 and 37 of the mounting plate 3. So, high speed data transmissions can be performed.

The optical connections are insensitive to electromagnetic perturbances, contrarily to material connections.

Reductions of the sizes of the devices and systems can be obtained.

The cost of the complete devices and systems is reduced with respect to devices comprising discrete components.

Referring now to FIG. 2, as another example, it can be seen that an integrated circuit system 1a is represented, comprising the integrated circuit device or package 2, corresponding to the above-described example, and a connection mounting plate 42.

This mounting plate 42 differs from the mounting plate 3 in that the optical wave-guide parts 36 and 37 are replaced by optical fibers 43 and 44 which transverse crossing passages 45 and 46 of the mounting plate 42 and which are attached to the last by means of mounting rings 47 and 48.

The end parts of the fibers 43 and 44 extend in prolongation of the optical wave-guide elements 10 and 11 and have radial end faces 49 and 50 optically coupled to the radial end faces 40 and 41 of these elements 10 and 11. The end faces 40 and 41 can be close to or in contact with the end faces 49 and 50. The end portions of the optical wave-guide elements 10 and 11 can extend in the rings 47 and 48.

So, the data exchanges can be transferred by the fibers 43 and 44 to or from other components carried by the mounting plate 42 or provided in another place.

Although embodiments of the devices and systems of the present invention have been illustrated in the accompanying drawings and described in the foregoing detailed description, it will be understood that the disclosure is not limited to the embodiments disclosed, but is capable of numerous rearrangements, modifications and substitutions without departing from the spirit of the disclosure.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An integrated circuit device comprising:
a laminated substrate,
an electro-optical element at least partially positioned in the laminated substrate, and
an optical wave-guide element at least partially positioned in the laminated substrate and optically coupled to the electro-optical element.

2. A device according to claim 1, in which the laminated substrate comprises a cavity in which the electro-optical element and the optical wave-guide element are at least partially positioned.

3. A device according to claim 1, in which the laminated substrate includes an electrical connection network connected to the electro-optical element.

4. A device according to claim 1, in which the optical wave-guide element includes a fixing end part positioned in the laminate substrate and optically coupled to the electro-optical element and another end part positioned outside of the laminated substrate.

5. A device according to claim 1, in which the laminated substrate comprises a cavity in which the electro-optical element and a fixing end part of the optical wave-guide element are positioned.

6. A device according to claim 1, in which the optical wave-guide element includes a fixing end part having a peripheral shoulder positioned in a passage of a core layer of the laminated substrate.

7. A device according to claim 6, in which the laminated substrate includes a side layer placed above a side of the core layer.

8. A device according to claim 1, in which the laminated substrate includes:
a core layer having a through-passage in which the electro-optical element and a shoulder of a fixing end part of the optical wave-guide element are positioned; and
first and second side layers respectively placed above first and second sides of the core layer, the first side layer extending above the electro-optical element and the second side layer extending above the shoulder of the optical wave-guide element.

9. A device according to claim 1, comprising:
an integrated circuit die located at an opposite side of the laminated substrate with respect to the optical wave-guide element; and
an electrical connection network coupled to the integrated circuit die.

10. A device according to claim 9, comprising:
an encapsulating structure encapsulating the integrated circuit die; and
an electrical connector connecting the integrated circuit die and the electrical connection network.

11. An integrated circuit system, comprising:
an integrated circuit device that includes:
a laminated substrate,
an electro-optical element at least partially positioned in the laminated substrate, and
an optical wave-guide element at least partially positioned in the laminated substrate and optically coupled to the electro-optical element;
a mounting plate on which the integrated circuit device is mounted; and
an electrical connector placed between the laminated substrate and the mounting plate.

12. An integrated circuit system according to claim 11, wherein the mounting plate includes an optical wave-guide part coupled to the optical wave-guide element.

13. An integrated circuit system according to claim 11, wherein the mounting plate carries an optical wave-guide fiber having an end coupled to the optical wave-guide element.

14. A system according to claim 13, in which the optical wave-guide fiber extends through a crossing hole of the mounting plate.

15. A system according to claim 14, in which the optical wave-guide fiber is fixed to the mounting plate by at least a ring.

16. A system according to claim 15, in which the optical wave-guide element has an end part in said ring.

17. A system, comprising:
a laminated substrate,
an electro-optical element at least partially positioned in the laminated substrate, and
an optical wave-guide element at least partially positioned in the laminated substrate and optically coupled to the electro-optical element; and
a mounting plate on which the laminated substrate is mounted.

18. A system according to claim 17, wherein the mounting plate includes an optical wave-guide part coupled to the optical wave-guide element.

19. A system according to claim 17, wherein the mounting plate carries an optical wave-guide fiber having an end coupled to the optical wave-guide element.

20. A system according to claim 17, in which the optical wave-guide element includes a fixing end part positioned in the laminate substrate and optically coupled to the electro-optical element and another end part positioned outside of the laminated substrate, the system further comprising a connector positioned between the laminated substrate and the mounting part, the mounting plate being spaced apart from the laminated substrate by the connector and the another end part of the optical wave-guide element being positioned in a space between the mounting plate and the laminated substrate.
